(19) United States
(12) Patent Application Publication
(10) Pub. No.: US 2026/0172830 A1
(43) Pub. Date: Jun. 18, 2026

(54) METHOD AND APPARATUS FOR AUTHORIZATION OF MOBILE JOINT COMMUNICATION SENSING SERVICE(S)

(71) Applicant: Huawei Technologies Co., Ltd., Shenzhen (CN)

(72) Inventors: Zhixian Xiang, Frisco, TX (US); Khosrow Tony Saboorian, Plano, TX (US); Abbas Kiani, Vieanna, VA (US); Kaippallimalil Mathew John, Carrollton, TX (US)

(21) Appl. No.: 19/368,878

(22) Filed: Oct. 24, 2025

Related U.S. Application Data
(63) Continuation of application No. PCT/US2024/025862, filed on Apr. 23, 2024.
(60) Provisional application No. 63/498,666, filed on Apr. 27, 2023.

(51) Int. Cl. H04W 12/08; H04W 4/38

(52) U.S. Cl. CPC H04W 12/08; H04W 4/38

(57) ABSTRACT

According to embodiments, an ISMF entity receives, from an ISAC service client, a sensing service request for an ISAC service or an ISAC operation. The sensing service request includes service information for at least one sensing entity associated with the ISAC service or the ISAC operation. The ISMF entity conducts an authorization procedure to obtain sensing service authorization to authorize the ISAC service or the ISAC operation. The ISMF entity coordinates sensing in accordance with an authorization result of the authorization procedure and the sensing service request.

### CROSS-REFERENCE TO RELATED APPLICATIONS

This application is a continuation of International Application No. PCT/US2024/025862, filed on Apr. 23, 2024 and entitled “Method and Apparatus for Authorization of Mobile Joint Communication Sensing Service(s),” which claims priority to U.S. Provisional Patent Application No. 63/498,666 , filed on Apr. 27, 2023 and entitled “New Mechanism for Authorization of Mobile Joint Communication Sensing Service(s),” applications of which are incorporated herein by reference in their entirety.

### TECHNICAL FIELD

The present disclosure relates generally to wireless communications, and, in particular embodiments, to methods and apparatus for sensing service(s).

### BACKGROUND

Third Generation Partnership Project (3GPP) has started to consider leveraging the radio communication resources and capabilities to provide sensing functionality starting from release 19. A 3GPP Service and System Aspects 1 (SA1) study item on integrated sensing and communication (ISAC) has been completed. An SA1 work item will start to finalize the normative requirements for release 19 based on the results from the study. After the completion of the SA1 work, other technical working groups (WGs) of 3GPP will start to develop and standardize ISAC technical solutions based on the use cases and requirements created by that SA1 work item.

FIG. 1 illustrates an example mobile ISAC system diagram. The sensing client (e.g., ISAC client 102) interacts with the mobile core network 104 to request the sensing service/operation. The mobile core network 104 instructs the ISAC sensing entities (e.g., ISAC sensing transmitter 106 and ISAC sensing receiver 108) to perform sensing operations to sense sensing target 110. For example, the ISAC transmitter 106 may emit radio waves. One or more ISAC receivers (e.g., ISAC receiver 108) may receive the radio waves reflected by the sensing target 110, perform sensing measurement and send the measurement result to the mobile core network 114 for further processing for the ISAC client 102.

### SUMMARY

Technical advantages are generally achieved, by embodiments of this disclosure which describe methods and apparatus.

According to embodiments, an ISMF entity receives, from an ISAC service client, a sensing service request for an ISAC service or an ISAC operation. The sensing service request includes service information for at least one sensing entity associated with the ISAC service or the ISAC operation. The ISMF entity conducts an authorization procedure to obtain sensing service authorization to authorize the ISAC service or the ISAC operation. The ISMF entity coordinates sensing in accordance with an authorization result of the authorization procedure and the sensing service request.

In some embodiments, the service information in the sensing service request may indicate at least one of a sensing area, potential target characteristics, a sensing operation time, a frequency of the ISAC service or the ISAC operation.

In some embodiments, to conduct the authorization procedure, the ISMF entity may send a sensing service authorization request including the service information to one or more network function entities in a network. The one or more network function entities may perform the sensing service authorization based on the service information. The ISMF entity may also receive the authorization result from the one or more network function entities based on a sensing authorization policy.

In some embodiments, the sensing service authorization may further select the at least one sensing entity associated with the ISAC service or the ISAC operation.

In some embodiments, the one or more network function entities may perform the sensing on communication resources managed by a communication system including the ISMF entity and the one or more network function entities.

In some embodiments, the ISMF entity may receive an update to the sensing service authorization. The ISMF entity may process the update to the sensing service authorization.

In some embodiments, to process the update to the sensing service authorization, the ISMF entity may discontinue the sensing on the communication resources in response to the update to the sensing service authorization.

In some embodiments, the ISMF entity may receive, from a second network function entity, an indicator indicating that the ISAC sensing service previously authorized shall not continue based on a sensing service policy. The ISMF entity may send, to the ISAC service client, a notification notifying a revocation of the sensing service authorization. The ISMF entity may send to one or more network function entities that perform the sensing, a termination request for the one or more network function entities to terminate the ISAC service or the ISAC operation.

In some embodiments, the notification may further indicate a subsequent action after the revocation.

In some embodiments, the sensing service policy may include restriction information. The restriction information may indicate at least one of an area restriction, a time restriction, a type of the ISAC service, a quality of service (QoS) of the ISAC service, or a sensing entity.

In some embodiments, the area restriction may include vertical and horizontal restrictions. The time restriction may include a time duration length or a time window in a day, in a month, or in a year.

In some embodiments, to coordinate the sensing, the ISMF entity may select the at least one sensing entity based on the authorization result. The at least one sensing entity may include a sensing transmitter and at least a sensing receiver. The ISMF entity may transmit a sensing service creation message to the at least one sensing entity. The ISMF entity may receive initial sensing data from the sensing receiver.

In some embodiments, to select the at least one sensing entity, the ISMF entity may select the at least one sensing entity based on the authorization result and a local selection policy at the ISMF entity.

In some embodiments, the local selection policy may be configured locally at the ISMF entity or provisioned to the ISMF entity from a network function entity that stores sensing service subscription information.

In some embodiments, the local selection policy may be based on a sensing area, a sensing time, an individual sensing service, or a sensing client.

In some embodiments, to select the at least one sensing entity, the ISMF entity may select the at least one sensing entity based on the authorization result from a sensing authorization function (SAF) entity. The authorization result may indicate the at least one sensing entity.

In some embodiments, the ISMF entity may send, to the ISAC service client, sensing result information based on the initial sensing data.

In some embodiments, the at least one sensing entity may include a base station and a user equipment (UE).

According to embodiments, an ISAC service client transmits a sensing service request for an ISAC service or an ISAC operation. The sensing service request includes service information for sensing entities associated with the ISAC service or the ISAC operation. The ISAC service client receives a response to the sensing service request. The response indicates a status of the sensing service request. The status indicates a sensing service authorization success or a sensing service authorization failure.

In some embodiments, the status may indicate the sensing service authorization success. The ISAC service client may receive sensing result information according to the sensing service request.

In some embodiments, the ISAC service client may receive a notification notifying a revocation of sensing service authorization corresponding to the ISAC service or the ISAC operation. The notification may further include a request indicating a subsequent action after the revocation.

In some embodiments, the service information in the sensing service request may indicate at least one of a sensing area, potential target characteristics, a sensing operation time, a frequency of the ISAC service or the ISAC operation.

In some embodiments, the ISAC service client may be or may be part of a user equipment (UE) or an application server.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows an example mobile ISAC system diagram, according to some embodiments;

FIG. 2A shows an example of an architecture of a mobile network system, according to some embodiments;

FIG. 2B shows an example sensing service system architecture, according to some embodiments;

FIG. 3 shows a flow chart of the procedure for sensing service authorization, according to some embodiments;

FIG. 4 shows a time diagram of an example procedure of sensing service revocation, according to some embodiments;

FIGS. 5A-5B show a flow chart of the example procedure of sensing service revocation, according to some embodiments;

FIG. 6A shows a flow chart of a method 600 performed by an ISMF entity, according to some embodiments;

FIG. 6B shows a flow chart of a method 600 performed by an ISAC service client, according to some embodiments;

FIG. 7 illustrates an example communications system, according to embodiments;

FIG. 8 illustrates an example communication system, according to some embodiments;

FIGS. 9A and 9B illustrate example devices that may implement the methods and teachings according to this disclosure; and

FIG. 10 is a block diagram of a computing system that may be used for implementing the devices and methods disclosed herein.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

Most of the existing services provided by a mobile network need to go through an authorization process in order to authorize a service or operation before all the related network functions can work together to deliver that service.

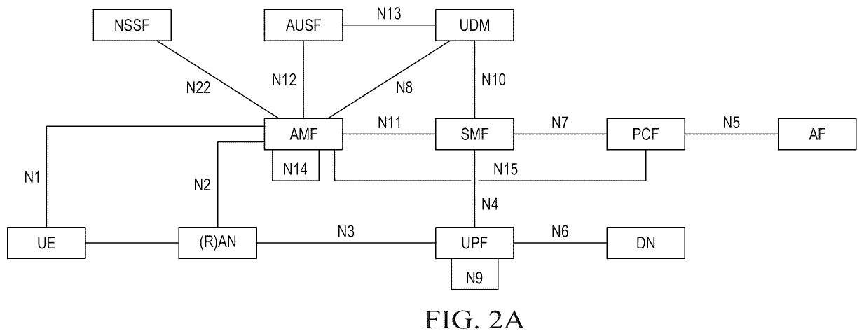

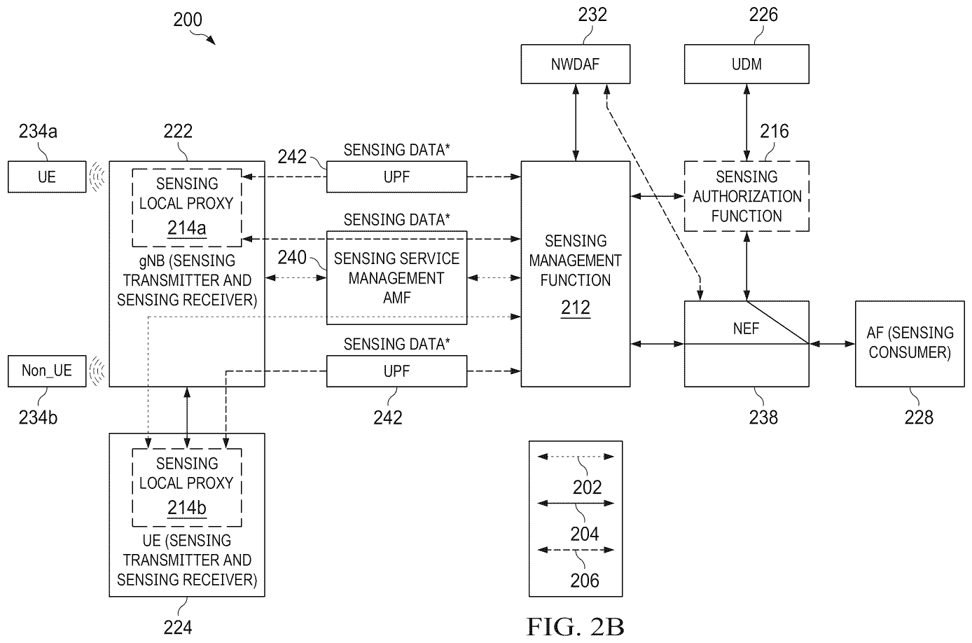

With the update of mobile communication technologies, mobile networks (5G networks) are constructed in a flexible and efficient manner. For example, a system architecture of a mobile network (e.g., a 5G network) may be shown in FIG. 2A. Functions of a terminal device and various network entities in FIG. 2A are described below.

Terminal device: The terminal device may also be referred to as a user equipment (UE), an access terminal, a terminal device unit (subscriber unit), a terminal device station, a mobile station, or a mobile station (MS), a remote station, a remote terminal, a mobile device, a user terminal, a terminal, a wireless communication device, a terminal device agent, or a terminal device apparatus.

Radio access network (RAN): The radio access network is a network including a plurality of 5G-RAN nodes, and implements a radio physical layer function, resource scheduling and radio resource management, radio access control, and a mobility management function. A 5G-RAN is connected to a UPF through a user plane interface N3, and is configured to transmit data of a terminal device. The 5G-RAN establishes a control plane signaling connection to an AMF through a control plane interface N2, to implement functions such as radio access bearer control.

AMF (access and mobility management function): The AMF is responsible for UE authentication, UE mobility management, network slice selection, and service management function (SMF) selection, functions as an anchor of a signaling connection between N1 and N2, provides a route of an N1/N2 service management (SM) message for an SMF, and maintains and manages UE status information.

UPF (user plane function): The UPF serves as an anchor point of a PDU session connection, and is responsible for data packet filtering, data transmission/forwarding, rate control, charging information generation, and the like of user equipment.

Unified data management (UDM): The unified data management is mainly used to manage and control user data, for example, management of subscription information, including obtaining subscription information from a unified data repository (UDR) and providing the subscription information to another network element (for example, an AMF); generating an authentication credential of a third generation partnership project (3GPP) for a UE; and registering and maintaining a network element currently serving the UE, for example, an AMF currently serving the UE (that is, a serving AMF).

Network exposure function (NEF): The network exposure function is used for connection and interaction between another internal network element of a core network and an external application server of the core network, to provide network capability information for the external application server, or provide information about the external application server for a core network element.

Application function (AF): The application function interacts with a core network element to provide some services, for example, interacts with a policy and control function (PCF) to perform service policy control, interacts with an NEF to obtain some network capability information or provide some application information for a network, and provides some data network access point information for a PCF to generate routing information of a corresponding data service.

Authentication server function (AUSF): The authentication server function is used to perform security authentication on a UE when the UE accesses a network.

Network slice selection function (NSSF): The network slice selection function selects a slice instance set for a UE and determines an AMF set and allowed NSSAI for the UE.

PCF (policy control function): The PCF provides configuration policy information for a UE, and provides policy information for a control plane network element (for example, an AMF or an SMF) of a network to manage and control the UE.

Network functions are entities in the mobile core network. For example, AMF, UPF, UDM, NEF, AF, AUSF, NSSF, and PDF are entities that may be part of the mobile core network (e.g., a 5G Core (5GC) network) of a cellular network.

Interfaces between network elements are shown in FIG. 2A. In FIG. 2A, names and functions of the interfaces between the network elements are as follows.
(1) N1 represents an interface between the AMF and the terminal, and may be configured to transfer a QoS control rule to the terminal device, and the like.
(2) N2 represents an interface between the AMF and the RAN, and may be configured to transfer radio bearer control information and the like from a core network side to the RAN.
(3) N3 represents an interface between the RAN and the UPF, and is mainly configured to transmit uplink and downlink user plane data between the RAN and the UPF.
(4) N4 represents an interface between the SMF and the UPF, and may be configured to transfer information between a control plane and a user plane, including delivery of forwarding rules, QoS control rules, traffic statistics rules, and the like from the control plane to the user plane, and reporting of user plane information.
(5) N5 represents an interface between the AF and the PCF, and may be configured to deliver an application service request and report a network event.
(6) N6 represents an interface between the UPF and the DN, and is configured to transmit uplink and downlink user data flows between the UPF and the DN.
(7) N7 represents an interface between the PCF and the SMF, and may be configured to deliver a protocol data unit (PDU) session granularity control policy and a service data flow granularity control policy.
(8) N8 represents an interface between the AMF and the UDM, and may be used by the AMF to obtain, from the UDM, subscription data and authentication data related to access and mobility management, and used by the AMF to register current mobility management related information of the terminal with the UDM.
(9) N9 represents a user plane interface between the UPFs, and is configured to transmit uplink and downlink user data flows between the UPFs.
(10) N10 represents an interface between the SMF and the UDM, and may be used by the SMF to obtain, from the UDM, subscription data related to session management, and used by the SMF to register current session related information of the terminal with the UDM.
(11) N11 represents an interface between the SMF and the AMF, and may be configured to transfer PDU session tunnel information between the RAN and the UPF, transfer a control message to be sent to the terminal, transfer radio resource control information to be sent to the RAN, and the like.
(12) N12 represents an interface between the AMF and the AUSF, and may be used by the AMF to initiate an authentication process to the AUSF, where an SUCI may be carried as a subscription identifier.
(13) N13 represents an interface between the UDM and the AUSF, and may be used by the AUSF to obtain a user authentication vector from the UDM, to perform an authentication process.
(14) N15 represents an interface between the PCF and the AMF, and may be configured to deliver a terminal policy and an access control related policy.

The network elements or the functions may be network elements in a hardware device, may be software functions running on dedicated hardware, or may be virtualized functions instantiated on a platform (for example, a cloud platform). Optionally, the network elements or the functions may be implemented by one device, or may be jointly implemented by a plurality of devices, or may be one functional module in one device. This is not specifically limited in embodiments of this application.

The access network device in embodiments of this application may be a radio access network device.

In addition, the “network element” may also be referred to as an entity, a device, an apparatus, a module, or the like. This is not particularly limited in this application. Moreover, for ease of understanding and description, descriptions of the “network element” are omitted in some of the following descriptions. For example, the NEF network element is referred to as an NEF for short. In this case, the “NEF” should be understood as an NEF network element or an NEF entity. Descriptions of same or similar cases are omitted below.

It should be understood that FIG. 2A is merely an example of a network architecture, and the network architecture applicable to embodiments of this application is not limited thereto. Any network architecture that can implement functions of the foregoing network elements is applicable to embodiments of this application.

For example, in some network architectures, network function entities such as the AMF, the SMF, the PCF, and the UDM are all referred to as network function (NF) network elements. Alternatively, in some other network architectures, a set of network elements such as the AMF, the SMF, the PCF, and the UDM may be referred to as a control plane function (CPF) network element.

The following uses the network elements in the 5G system as an example to describe specific solution details. It may be understood that when the solution is applied to an LTE system or a future communication system, each network element in the solution may be replaced with another network element having a corresponding function. This is not limited in this application.

All existing 3GPP-defined mobile services provided by a mobile network (e.g., the mobile network shown in FIG. 2A) are associated with a user equipment (UE), where certain communication connection(s) has been or will be established with the network or other UE(s). Therefore, the existing authorization mechanisms for fifth generation (5G) connectivity and the mobile-based services (e.g., LoCation Service (LCS)) that the user is allowed to access are all conducted based on the UE's subscription (e.g., operator determined barring, roaming restrictions, access type, and radio access technology (RAT) type that are currently in use) after the UE is successfully identified and authenticated. For example, when the network conducts authorization for certain mobile services, the authorization process is always associated with a certain UE and the UE's subscription. Also, normally the network authorization function is combined with an authentication function to be part of a single security function authentication server function (AUSF) or authentication, authorization, and accounting (AAA) for the UE's authentication and authorization. However, for sensing, the sensing target may not be a UE but a non-communication object (e.g., an unmanned aerial vehicle (UAV), a human being, a car, so on), which may be unknown to the network beforehand. In addition, the consumer of the sensing service may not be a UE or a mobile user. So, an ISAC service and operation may only rely on the communication resources in the network without any UE being involved. With this consideration, a new sensing service and operation authorization mechanism is needed within mobile networks, which may or may not be associated with any UE or mobile user in the mobile network.

Also, there can be privacy or regulatory concerns associated with the sensing service and operation. For example, the sensing operation to the target(s) or sensing environment without consent from the target person or owner of the target may cause concern to the sensing target or the owner of the target(s). Also, the sensing areas can be restricted areas (e.g., military areas, areas related to public safety and government security), where only communication service may be allowed but not sensing service.

In addition, when there is an internal policy change (e.g., privacy modification), or when the target moves into a restricted sensing area, or when the network condition changes, the authorized service can be revoked, which means that the service is no longer authorized.

When revoked, the service can be suspended temporarily or terminated, and a new authorization may be required to continue the service. For example, a car with autonomous driving capability and a mobile sensing entity is authorized to use a mobile sensing service in city A. However, when the car approaches a restricted area (e.g., a military area) in city A, the authorization to use the mobile sensing service is revoked by the mobile operator. A notification indicating that autonomous driving is disabled is provided, so the car cannot use the mobile sensing service in the restricted area anymore until the car is away from the restricted area. In another example, a person uses a phone as the mobile sensing entity to track his/her movement, but when the person enters a restricted area (e.g., a public locker room), the sensing service should be stopped. There is no existing solution to address the service revocation related to policy change or other condition changes, and the existing standard solution only supports the termination initiated by the application function (AF) or the network without revoking the authorization. Without revoking the authorization, the user can assume that the service or operation is still authorized, which can lead to subsequent incorrect actions.

There is a 3GPP-defined LCS service that can be used for tracking, which could be similar to sensing, but this disclosure is different compared to the LCS operation as the example illustrates below.

For example, a person is riding his motorcycle across the country. His family is tracking his location based on information provided by his phone. When the person rides past a military area, his family is unable to track him because the area does not have the cellular service. After he rides past the military area, the location tracking resumes because the cellular service resumed.

For this use case, if the existing LCS solution is used, the communication and location service are still authorized and on until the keep live timer expires-the UE temporarily loses the connection and will resume the service once the connection is restored. However, by using embodiment techniques of this disclosure, the network can, based on the policy and condition, revoke the previously granted authorization for the service and stop the service. Because of the revocation notification from the network, the sensing user knows why the sensing service is stopped and may know how to resume the sensing service. This disclosure provides better user experience and better central control to address the public security and privacy concerns of the current conventional solutions.

This disclosure introduces a sensing service architecture and authorization mechanism to allow the mobile network to authorize and revoke the authorization of an integrated sensing and communication service and/or operation to sensing target(s). In the disclosed sensing service architecture and authorization mechanism, the target may or may not be UE(s). Further, the target may or may not have communications with the network. To help explain the embodiment techniques and for the purpose of illustration, non-limiting descriptions of the following terms are provided below.

3GPP sensing data: data derived from 3GPP radio signals impacted (e.g. reflected, refracted, diffracted) by an object or environment of interest for sensing purposes, and optionally processed within the 5G system.

5G Wireless sensing: 5G feature providing capabilities to get information about characteristics of the environment and/or objects within the environment (e.g. shape, size, orientation, speed, location, distances, or relative motion between objects, etc.) using new radio (NR) radio frequency (RF) signals and, in some cases, previously defined information available in evolved packet core (EPC) and/or evolved universal terrestrial radio access (E-UTRA).

Sensing receiver: an entity that receives the sensing signal which the sensing service will use in the sensing service's operation. A sensing receiver may be an NR radio access network (RAN) node or a UE. A sensing receiver can be located in the same or different entity as the sensing transmitter.

Sensing target area: an area that needs to be sensed by deriving the dynamic characteristics of the area from any moving obstacles (e.g. cars, humans, animals) from the impacted (e.g. reflected, refracted, diffracted) wireless signals. There can be 2 types of target areas:
Static sensing target area: a pre-defined area that does not move from the sensing transmitter's perspective.
Moving sensing target area: a trusted zone with a target that moves from the sensing transmitter's perspective.

Sensing transmitter: the entity that sends out the sensing signal which the sensing service will use in the sensing service's operation. A sensing transmitter may be an NR RAN node or a UE. A sensing transmitter can be located in the same or different entity as the sensing receiver.

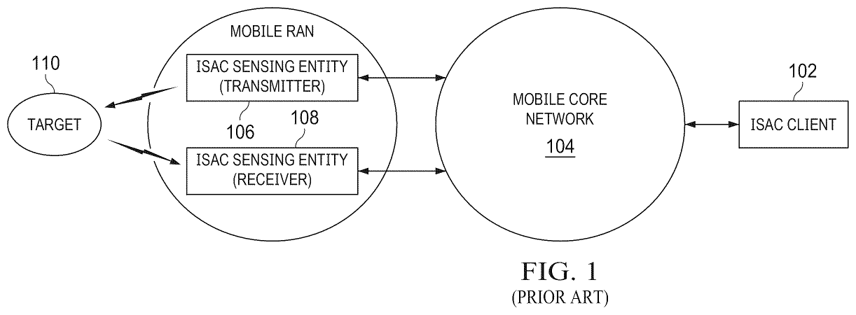

This disclosure provides a sensing service system architecture based on the 3GPP defined service-based architecture. A sensing service is a network service provided by the mobile network to track a target. In some examples, a sensing service may be a drone tracking sensing service that is a service for tracking a drone, using the techniques described with respect to, but not limited to, FIG. 1 above. For example, the sensing service (e.g., the drone tracking sensing service) may communicate with the target (e.g., a drone) over cellular network resources (e.g., communication resources described in this disclosure) to determine the target's location and/or movement. In another example, the sensing service (e.g., the drone tracking sensing service) may use other types of sensors, such as a camera or a LiDAR (light detection and ranging), that do not operate on cellular network resources to detect the target's location and/or movement. In yet another example, the sensing service (e.g., the drone tracking sensing service) may utilize a sensing transmitter to emit radio waves and utilize sensing receiver(s) to detect these radio waves after they reflect off the target (e.g., the drone). The sensing service may then process the reflected radio waves received by the sensing receiver(s) to determine the target's location and/or movement. The sensing service processes the received radio waves s to determine the target's location and/or movement, enabling tracking of the target.

Each different sensing service may have a different corresponding quality of service (QoS) and a different sensing profile. A sensing operation is the operation performed on the sensing service, such as activation/modification/termination/suspension of the sensing service. An example of the sensing service system architecture is illustrated in FIG. 2B. The sensing service architecture 200 may add modifications to the system architecture of the mobile network shown in FIG. 2A. For example, the sensing service architecture 200 further includes 3 new network functions: ISAC sensing management function (ISMF) 212, sensing local proxy function (SLPF) 214, and sensing authorization function (SAF) 216 in the mobile core network (e.g., the 5GC network). Additional network functions related to sensing service can be added later if needed.

ISMF 212 can be responsible mainly for (1) managing the sensing operation (creation/modification/termination/suspension/revocation), including coordinating with different necessary network functions or UEs to conduct sensing operations; (2) selecting ISAC signal entities (transmitter/receiver) for one sensing service; (3) calculating and providing the final sensing result to the sensing consumer using the data collected from the RAN and UEs which use radio technologies (including other non-3GPP sensing technologies, such as wireless fidelity (WiFi), light detection and ranging (LiDAR), so on). This ISMF 212 can be part of 5G core or be distributed to RAN.

There may be two sub-functions within the ISMF 212. These two sub-functions can be also implemented as individual functions or implemented within one ISMF 212. The sensing data processing function in the ISMF 212 may be used for processing sensing data and producing the sensing result. The sensing data processing function resides in the sensing data plane. The sensing control function in the ISMF 212 may be used for sensing service and operation management. The sensing control function resides in sensing control plane.

SLPF 214 may be responsible for local sensing management residing in the ISAC entities (transmitter/receiver) which can be either RAN including gNB 222 (e.g., SLPF 214a) or UE 224 (e.g., SLPF 214b). SLPF 214 is responsible for using mobile communication resources to conduct sensing operation, collecting sensing data, conducting local process and analysis on the sensing data per the request from the ISMF 212. For some implementations, such as when the sensing entities are UEs using sidelink communication or the sensing consumer is the RAN management function for communication optimization, the SLPF 214 can be a mini version of the ISMF to manage the sensing operation locally and provide the sensing result for network internal consumers.

SAF 216 may be responsible for authorizing the sensing service and sensing operation. For example, after the SAF 216 receives the service authorization request sent from the ISMF 212, the SAF may check the sensing authorization policy against the information in the service authorization request (e.g., the sensing service client ID, the request type, the service ID, the sensing operation type, the target character, the target ID, the sensing area, and/or the time period) to perform the authorization to determine whether the requested sensing service and/or sensing operation is allowed to be performed. After performing the authorization, the SAF 216 sends the authorization response indicating the result of the authorization to the ISMF 212. SAF 216 can be implemented as part of ISMF 212, or a standalone function. SAF 216 contains sensing service authorization policy/policies which can be configured and modified by mobile operators or other authorized third parties. SAF 216 conducts authorization for sensing service(s) based on the sensing authorization policy. SAF 216 can be part of 3GPP core network which is used for authorizing the sensing service request from the sensing service consumer. The sensing authorization policy can be provisioned by the unified data management (UDM) 226, application function (AF) 228, or other policy management functions, or can be configured locally within the SAF 216.

The existing UDM 226 may be enhanced to contain the sensing service related policy, including the sensing authorization policy. The UDM 226 can provision and update the sensing service policy to the ISMF 212, SLPM 214 and SAF 216.

The existing network data analytics function (NWDAF) 232 may be enhanced to be able to: (1) collect sensing information from the ISFM to produce sensing related analytic output data to other network functions (e.g., enhancing NWDAF output data with sensing information), which can be used for communication optimization; and (2) to provide some sensing information or sensing related analytic data to the ISMF 212 to help sensing operation, such as for sensing entity selection, or the ISMF 212 can leverage communication resource improve management for the sensing operation (e.g., schedule communication resource more efficiently based on the blockage conditions between target UE 234a and gNB 222).

The ISMF 212 interacts with the external sensing client (e.g., AF 228) via the existing network exposure function (NEF) 238. The interfaces are enhanced with information provided by the sensing consumer (e.g., AF 228) for sensing authorization. In FIG. 2B, the interfaces/reference points which are linked to the SAF 216 and the ISMF 212 can be new interface/reference points. Further, sensing client and sensing consumer (e.g., AF 228) can be the same. The sensing target can be a UE (e.g., UE 234a) or a non-UE 234b (e.g., a human, an object, or some other entity that does not transmit on the resources used by the sensing service architecture 200).

In FIG. 2B, Lines 202 represent the control plane of the sensing operation over which sensing management data is transported, Lines 204 represent the data plane of the sensing operation over which all the sensing measurement data is transported, and Lines 206 represent the option in which the data plane of the sensing operation is transported via the network user plane through the UPF function. In various embodiments, the sensing data may be transferred from the gNB 222 to the ISMF 212 via the access and mobility management function (AMF) 240, or directly using the data plane (e.g., using user plane function (UPF) 242) between the gNB 222 and the ISMF 212.

This embodiment introduces the authorization mechanism for ISAC service. There can be two levels of ISAC service operations: (1) ISAC service level operations, and (2) ISAC operation level operations. ISAC service level operations are related to the ISAC client's service configuration, such as creating, modifying, terminating, suspending, or revoking the services for the client. ISAC Operation level operations are related to the individual sensing actions related to one ISAC service, such as activating, modifying, terminating, suspending, or revoking an ISAC operation.

There can be three categories of authorization for integrated sensing and communications: (1) ISAC service authorization, (2) ISAC operation authorization, and (3) sensing entity authorization.

ISAC service authorization is the authorization for a service level operation. It is to authorize the sensing service (creation/modification/termination/suspension/revocation) (e.g., allowing users to change the service profile or configuration of the service, including changing the QoS requirements of the subscribed services; or restricting what kind of sensing services (tracking or detecting) are allowed for the sensing client under certain conditions, such as allowing users to use a detecting service but not a tracking service in a location for a defined duration). The sensing service is a service which is provided by the mobile network by using its communication resources and sensing capability to sense certain objects and environments within a certain area. The communication resources may be the time-frequency resources used by the UE(s) and the base station(s) for transmissions/receptions in a cellular network (such as the mobile networks shown in FIG. 2A and FIG. 2B). In some embodiments, time-frequency resources may correspond to orthogonal frequency-division multiplexing (OFDM) symbols and subcarriers within the OFDM symbols. In some embodiments, the smallest physical time-frequency resource consists of one subcarrier in one OFDM symbol, known as a resource element (RE). The transmissions may be scheduled in group(s) of 12 subcarriers, known as physical resource blocks (PRBs). In the time domain, the radio transmissions may be organized into radio frames, subframes, slots, and mini-slots. In some embodiments, each radio frame has a duration of 10 ms and consists of 10 subframes with a subframe duration of 1 ms. A subframe may be formed by one or multiple adjacent slots, each slot having 14 adjacent OFDM symbols. A mini-slot may be as short as one OFDM symbol. In some embodiments, mini-slots may be restricted to 2, 4, and 7 OFDM symbols. The frequency of the resources may optionally be a frequency used for mobile cellular communication.

The sensing service request can originate from an external customer (e.g., a third party application/service provider, a user) or internal customers which are the other network functions (e.g., operations, administration and maintenance (OAM), NWDAF) which can use the sensing information for other network services.

There can be different types of sensing services for authorization: (1) tracking service, which uses sensing capability to track particular target(s) (the ISAC client will provide characteristics of the target for the network to identify the target); (2) detecting serving, which uses the sensing capability to detect if certain object(s) are present in certain sensing areas; and (3) other types of sensing services.

Within the ISAC service authorization category, there can be different types of sensing service operations which require authorization: (1) sensing service creation: creating a new sensing service; (2) sensing service modification: modifying an existing sensing service configuration or profile, policy; (3) sensing service termination: terminating an existing sensing service; and (4) sensing service suspension: suspending an existing sensing service.

The ISAC service authorization category can be conducted in the sensing authorization function (e.g., SAF 216 in FIG. 2B).

ISAC operation authorization is for individual ISAC operation level authorization. ISAC operation authorization is to authorize the sensing service operation(s) (activation/modification/termination/suspension) for a sensing service. Compared to ISAC service authorization described above, ISAC operation authorization is a sensing operation level authorization (e.g., a user is allowed to have a sensing service in a particular location but may not be allowed to execute sensing operation (e.g., activate, suspend, or modify the sensing operation) at a certain time or location, or allowed to modify the sensing entity during an operation. The sensing operation request can originate from an external customer (e.g., a third party application/service provider, a user) or internal customers which are the other network functions (e.g., OAM, NWDAF) which can use sensing information in other network services. A sensing service may be associated with one or more sensing operations.

Within ISAC operation authorization category, there can be different types of sensing operations which require authorization, including: sensing operation modification, sensing operation termination, and sensing operation suspension. Sensing operation modification is for modifying an ongoing sensing operation for an ISAC service, such as changing the sensing entity or other communication result with or without sensing service changes (e.g., profile or policy changes). Sensing operation termination is for terminating an ongoing sensing operation for a sensing service with or without terminating the associated sensing service. Sensing operation suspension is for suspending an ongoing sensing operation with or without suspending the associated sensing service. The sensing operation category authorization may be conducted in the sensing authorization function, such as SAF 216.

Sensing entity authorization is the authorization for the ISAC entities (e.g., such as gNB, UE) to be selected as sensing signal transmitter(s)/receiver(s) and to be allowed to participate in a sensing service or operation. The sensing entity authorization can be associated with one particular sensing service for a sensing consumer (e.g., AF 228), or one type of sensing service, or one type of sensing operation. Within the sensing entity authorization category, there can be several types of authorization, such as sensing entity selection and sensing entity modification. Sensing entity selection is for authorizing the selection of the sensing entities (gNB or UE) to participate in a sensing service operation. Sensing entity modification is for authorizing the modification of the sensing entities (gNB or UE) which have been selected before a sensing service. The sensing entity authorization may be conducted in the sensing authorization function (e.g., SAF 216) or be conducted in sensing management function (e.g., ISMF 212).

The sensing service/operation request message from the ISAC client to the ISME (e.g., IMSF 212) or SAF (e.g., SAF 216), as well as the sensing authorization policy can contain the authorization category and the authorization type information within the category (e.g., service/operation type indicator for authorization) as described above.

Compared to the existing mobile service authorization policy, which is associated with the UE subscription, the embodiment sensing service authorization policy can include the following information: (1) authorization policy for the sensing service consumer; (2) regulation policy; (3) network operation policy; and (4) skip authorization indicator.

In general, an authorization process verifies whether certain access is allowed through policies and rules, usually described in the authorization policy. More specifically, the authorization policy for the sensing service consumer may include consumer/client identifier (ID); consumer's sensing service subscription and profile; sensing quality of service (QoS) performance agreement; operational restrictions for the consumer (e.g., operation time (such as time period, start time restriction), sensing location, interval or time periodicity of the operation or providing results to this client); the sensing target restrictions (e.g., certain type of target or sensing area cannot be used for the consumer, time restriction); sensing entity policy, such as whether or not to allow a UE to be the sensing transmitter or receiver for a sensing service, restrictions on using the UE to be sensing transmitter/receiver (such as maximum number of UEs to be used, location, time, so on).

The regulation policy is the privacy protection policy of the sensing target, sensing area (some areas can be restricted area for any sensing service or operation) during certain operational time periods. The regulation policy may be applied to all the sensing services or sensing clients in the same region.

The network operation policy may include the capability limitation of the mobile network sensing service, (e.g., certain sensing capabilities cannot be supported); Operator's own sensing operation restrictions, such as time, location, targets; sensing service priority or client priority (e.g., if the network is overloaded, lower priority sensing service(s) can be rejected).

The network operation policy may further include authorization policy of selection of sensing entities (transmitter/receiver, gNB or UE) for sensing service. The authorization policy can used for authorizing certain network function(s) or UE(s) to be used as a sensing entity (transmitter/receiver) for a sensing service, which may include load threshold (minimum, or maximum) for the network function or UE to be allowed to add a new service operation and restriction on selecting certain UE or RAN nodes for sensing operation, such as time and location.

The skip authorization indicator may be used to indicate if a certain operation is allowed to skip authorization (e.g., if the request is from the same client, in which the same type of requests have been authorized before and the authorization period has not expired; or the sensing service is for public emergency service). The skip authorization indicator can help speed up the resumed sensing service or operation. The skip authorization indicator can be associated with each sensing operation request.

The sensing consumer (e.g., AF 228) can provide the corresponding information according to the sensing authorization policy in the sensing service/operation request, and the authorization function (e.g., SAF 216) uses the corresponding information to match the policy to make the authorization decision.

The authorization request can come from the sensing service consumer or the mobile network user. The sensing service consumer can be an external third party entity, or other mobile network function.

The embodiment solution provides an authorization revocation mechanism for an authorized mobile sensing service or operation when a certain condition or policy has changed, such as either the network operator or service client policy has changed (e.g., the validity conditions or restriction for certain sensing operations have changed) which causes the ongoing sensing service not to meet the policy and need to be terminated, or the sensing operation condition has changed (e.g., the tracking target has moved to a restricted sensing area). The embodiment revocation is indicated to the ISAC client that the previously authorized service/operation is not valid, and that a new authorization may be needed later. The revocation can lead to either the termination or suspension of the sensing operation. The revocation notification can come from the authorization function (e.g., SAF 216) or the sensing management function (e.g., ISMF 212). The notification message contains the subsequent action (termination or suspension). If the subsequent action is suspension, a resume operation condition may be included, such as a waiting timer which the operation can be resumed after timer expires; a resume condition, such as in a new sensing area, or load threshold of communication resource for sensing reaches certain level, or restart at certain time, so on; waiting for the resume trigger from the authorization function (e.g., SAF 216) or the sensing management function (e.g., ISMF 212), or sensing consumer (e.g., AF 228) or other management functions/entities.

If the sensing client or the sensing entity(ies) have received a revocation notice, there are changes on connections, such as network changes (from one network to another network, or from cellular to WiFi). The sensing entity may still be unable to continue sensing because of revocation notice.

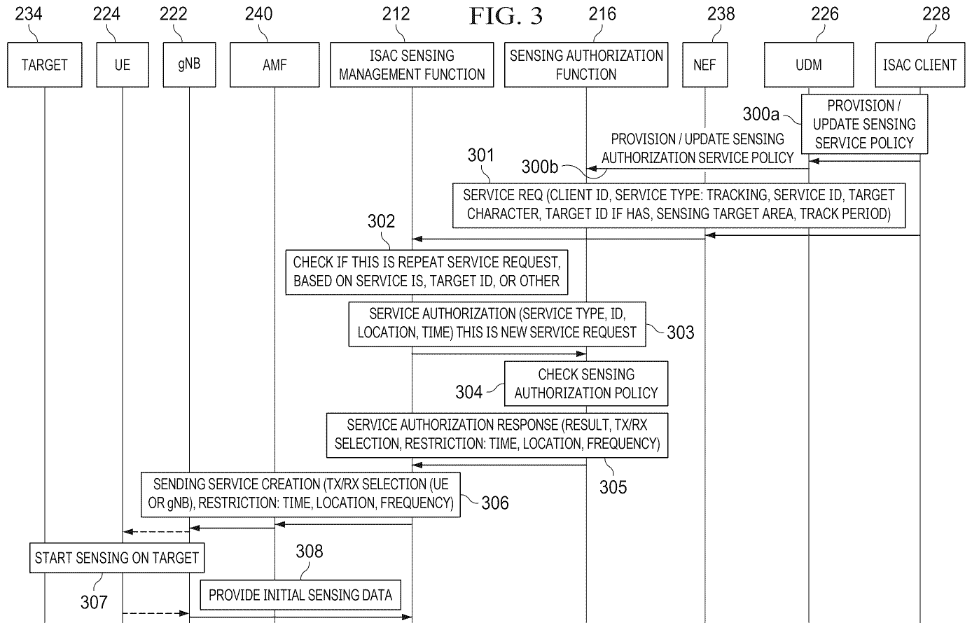

FIG. 3 shows a flow chart of a procedure for sensing service authorization, according to some embodiments. At the operation 300a, the ISAC client 228 provisions or updates its sensing service policy to the UDM 226 (or other customer policy function such as a policy control function (PCF)) of the network operator.

At the operation 300b, the UDM 226 provisions or updates the sensing service policy including the new updated policy from the ICAS client 228 to the SAF 216.

At the operation 301, the ISAC client 228 sends sensing service request message via the NEF 238 to the ISMF 212 with information including or indicating one or more of: the sensing service client ID, the request type (e.g., sensing service for tracking), a service ID, a sensing operation type (e.g., creation), a target character, a target ID if the target 234 (e.g., UE target 234a or non-UE target 234b) has been used before, a sensing area, and a time period.

At the operation 302, to prevent unnecessary transactions and reduce the latency to responding to the sensing service request, the mobile operator may allow the ISAC client 228 to request the same type of request multiple times without going through the normal authorization process within a valid period. The ISMF 212 may check whether the sensing service request is a repeat service request which has been requested before from the same client and meets the policy requirement (if the skip authorization indicator is on, and the request is in a valid time period) to skip the authorization.

At the operation 303, the ISMF 212 determines that this is a new sensing request, and that sensing authorization is needed. The ISMF 212 sends a service authorization request to the SAF 216 with the information (e.g., one or more of: the sensing service client ID, the request type, the service ID, the sensing operation type, the target character, the target ID, the sensing area, and the time period) provided by ISAC client 228 in the operation 301.

At the operation 304, the SAF 216 conducts authorization based on the sensing authorization policy. For example, after the SAF 216 receives the service authorization request sent from the ISMF 212 as described in the operation 303, the SAF may check the sensing authorization policy against the information in the service authorization request (e.g., the sensing service client ID, the request type, the service ID, the sensing operation type, the target character, the target ID, the sensing area, and/or the time period) to perform the authorization to determine whether the requested sensing service and/or sensing operation is allowed to be performed. Further, the result of the authorization may include additional information, such as possible operational restrictions for the sensing service and/or sensing operation (e.g., the requested sensing service and/or sensing operation can only be performed at a specific time, location, or within a specific time period). In addition, the result of the authorization may include selection of sensing entities (e.g., which sensing transmitter/receiver(s) are selected to track the target). There may be many combinations of sensing transmitter/receiver(s). The SAF 216 may determine the selection of the sensing entities from the candidate combinations of sensing transmitter/receiver(s) based on the service authorization request and a sensing entity selection policy. In some embodiments, the sensing entity selection policy may be part of the sensing authorization policy.

At the operation 305, after authorization, the SAF 216 sends the authorization response indicating the result of the authorization to the ISMF 212. For example, the authorization response may indicate a successful result, including some possible operational restrictions, such as the time, location, and/or time periodicity of the sensing operation. If the authorization fails, the authorization response sent by the SAF 216 may indicate a failure result with a reason code. In some embodiments, the authorization response may further indicate selection of sensing entities (e.g., which sensing transmitter/receiver(s) are selected by the SAF 216 during the authorization at the operation 306). In some other embodiments, the SAF 216 may select the sensing entities locally based on its local sensing entity selection policy and information in the sensing service request message received at the operation 301.

At the operation 306, if the authorization is successful, the ISMF 212 starts the sensing operation by selecting the sensing entities (e.g., gNB 222 and/or UE 224) and sends the sensing service creation request (optionally via the AMF 240) to the selected gNB 222 and/or UE 224. Optionally, the ISMF 212 may interact with the SAF 216 to get authorization on selecting those sensing entities (e.g., gNB 222 and/or UE 224) for the sensing service if the ISMF 212 does not store the policy locally. If the authorization response includes a failure indication, the ISMF 212 sends a sensing response with a reason code to the sensing client to notify the failure of the sensing request.

At the operation 307, the selected gNB 222 and/or UE 224 conducts sensing operation to track the target 234 and collect sensing data.

At the operation 308, the selected gNB 222 and/or UE 224 provides the collected sensing data to the ISMF 212, which will use the collected sensing data to create the final sensing result. There can be other options in which the ISMF 212 forwards the collected sensing data to a third party function to further process the data and provide the final sensing result.

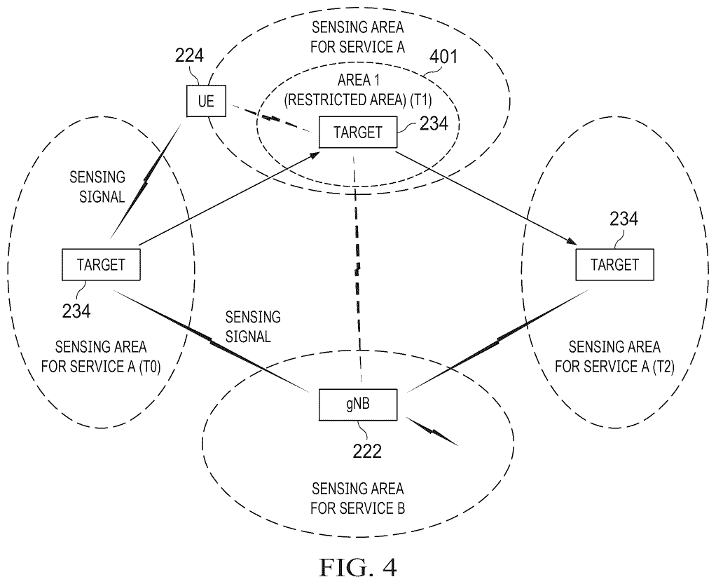

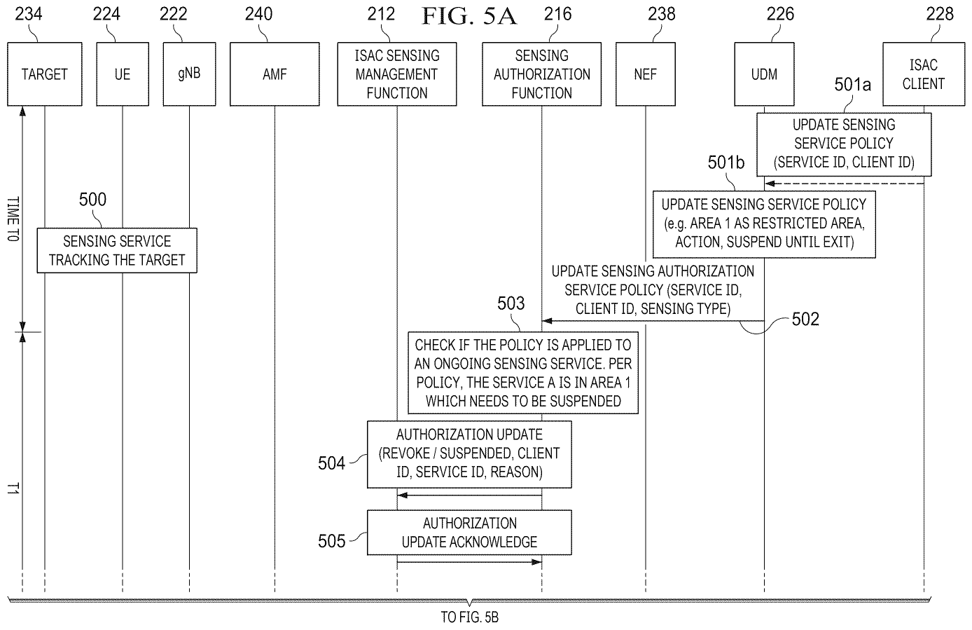

FIGS. 4 and 5 illustrate an example procedure of sensing service revocation, according to some embodiments. FIG. 4 shows a time diagram where a target is authorized for sensing service at time To, suspended (revoked) at time T1, and resumed at time T2. FIGS. 5A-5B show a flow chart of the procedure for sensing service revocation, according to some embodiments. FIGS. 4 and 5 are described in conjunction with each other below.

Operations 501A-503 may be performed during time To. During time To and the operation 500, the gNB 222 and the UE 224 are tracking the target 234 (e.g., UE target 234a or non-UE target 234b).

Optionally, at the operation 501A, the ISAC client 228 updates its sensing service policy to the UDM 226 (or other customer policy function, e.g., a PCF) of the network operator. The ISAC client 228's sensing service policy may indicate a service ID of the sensing service (e.g., Service A) and a client ID of the ISAC client 228.

Optionally, at the operation 501B, the Network operator also updates its sensing policy in the UDM 226 (e.g., denoting the area 401 as a sensitive restricted area so that no sensing service is allowed in the area 401). Sensing service or operation which meets this restriction will be suspended until the target 234 exits the area 401.

At the operation 502, the UDM 226 updates the sensing authorization policy to the SAF 216.

Operations 503-509 may be performed during time T1.

At the operation 503, the SAF 216 checks whether the updated sensing authorization policy can be applied to the ongoing sensing service. There can be multiple active ISAC services during that time. For example, the Service A is tracking the target 234, and, if the Service A's serving area is in the area 401 as the target 234 is moving into the area 401, the Service A needs to be suspended; while the Service B may be a detecting service, and, if the Service B's service area is not in the area 401, the Service B will not be impacted with this change.

At the operation 504, the SAF 216 sends an authorization update with a revocation notification with the subsequent action as suspended. The authorization update may indicate whether the sensing service (e.g., the Service A) is revoked or suspended, a client ID, a service ID of the sensing service, and a reason code.

At the operation 505, the ISMF 212 responds with an authorization update acknowledgement. If the SAF 216 is implemented as part of the ISMF 212, operations 504 and 505 can be internal transactions within the ISMF 212.

At the operation 506, the ISMF 212 sends a service request (indicating, for example, the suspension indication, the reason code, and the resume condition (e.g., upon the target exiting the area 401)) to sensing entities (the gNB 222 and/or the UE 224) (optionally via the AMF 240). The ISMF may send the service request using a non-access stratum (NAS) message.

At the operation 507, the gNB 222 and/or the UE 224 suspends the sensing Service A in the area 401.

At the operation 508, the gNB 222 and/or the UE 224 sends a sensing response to the ISMF 212 after suspending sensing Service A.

At the operation 509, the ISMF 212 sends a sensing notification to the ISAC client 228 after the suspension of sensing Service A indicating an authorization revocation indication and a reason code.

At the operation 510, the ISMF 212 is notified by other network functions or other mechanisms that the target 234 has left the area 401.

At the operation 511, the ISMF 212 sends a sensing service resume request to the gNB 222 and/or the UE 224 to restart/resume the sensing service.

At the operation 512, the gNB 222 and/or the UE 224 starts to track the target 234 again.

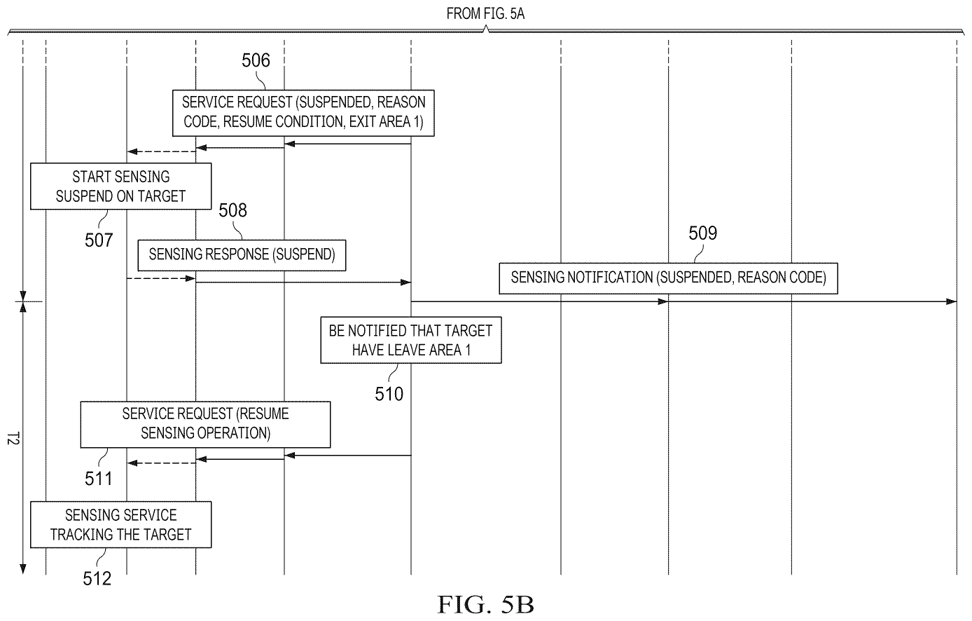

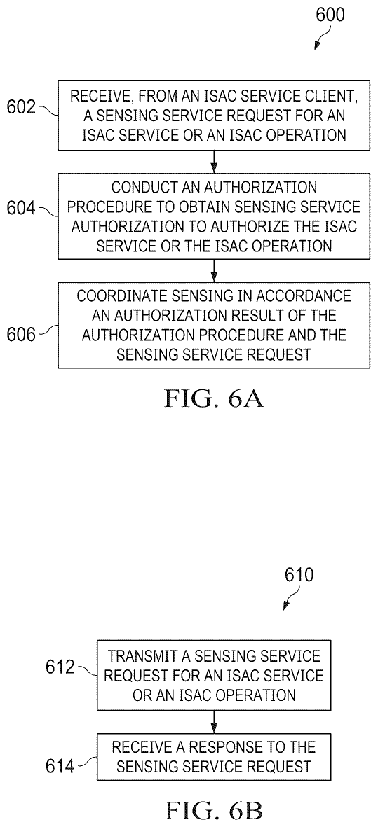

FIG. 6A shows a flow chart of a method 600 performed by an integrated sensing and communication (ISAC) service management function (ISMF) entity, such as ISMF 212, according to some embodiments. The ISMF entity may include computer-readable code or instructions executing on one or more processors of the ISMF entity. Coding of the software for carrying out or performing the method 600 is well within the scope of a person of ordinary skill in the art having regard to the present disclosure. The method 600 may include additional or fewer operations than those shown and described and may be carried out or performed in a different order. Computer-readable code or instructions of the software executable by the one or more processors may be stored on a non-transitory computer-readable medium, such as for example, the memory of the ISMF entity. In some embodiments, the method 600 may be performed by one or more of units or modules (e.g., an integrated circuit) of the ISMF entity, such as one or more field programmable gate arrays (FPGAs) or one or more application-specific integrated circuits (ASICs).

The method 600 starts at the operation 602, where the ISMF entity receives, from an ISAC service client, a sensing service request for an ISAC service or an ISAC operation. The sensing service request includes service information for sensing entities associated with the ISAC service or the ISAC operation. At the operation 604, the ISMF entity conducts an authorization procedure to obtain sensing service authorization to authorize the ISAC service or the ISAC operation. At the operation 606, the ISMF entity coordinates sensing in accordance with an authorization result of the authorization procedure and the sensing service request.

In some embodiments, the service information in the sensing service request may indicate at least one of a sensing area, potential target characteristics, a sensing operation time, a frequency of the ISAC service or the ISAC operation.

In some embodiments, to conduct the authorization procedure, the ISMF entity may send a sensing service authorization request including the service information to one or more network function entities in a network. The one or more network function entities may perform the sensing service authorization based on the service information. The ISMF entity may also receive the authorization result from the one or more network function entities based on a sensing authorization policy.

In some embodiments, the sensing service authorization may further select the at least one sensing entity associated with the ISAC service or the ISAC operation.

In some embodiments, the one or more network function entities may perform the sensing on communication resources managed by a communication system including the ISMF entity and the one or more network function entities.

In some embodiments, the ISMF entity may receive an update to the sensing service authorization. The ISMF entity may process the update to the sensing service authorization.

In some embodiments, to process the update to the sensing service authorization, the ISMF entity may discontinue the sensing on the communication resources in response to the update to the sensing service authorization.

In some embodiments, the ISMF entity may receive, from a second network function entity, an indicator indicating that the ISAC sensing service previously authorized shall not continue based on a sensing service policy. The ISMF entity may send, to the ISAC service client, a notification notifying a revocation of the sensing service authorization. The ISMF entity may send to one or more network function entities that perform the sensing, a termination request for the one or more network function entities to terminate the ISAC service or the ISAC operation.

In some embodiments, the notification may further indicate a subsequent action after the revocation.

In some embodiments, the sensing service policy may include restriction information. The restriction information may indicate at least one of an area restriction, a time restriction, a type of the ISAC service, a quality of service (QoS) of the ISAC service, or a sensing entity.

In some embodiments, the area restriction may including vertical and horizontal restrictions. Vertical restrictions refer to height restrictions in the vertical dimension (e.g. how high the sensing service can cover). Horizontal restrictions refer to the area restrictions in the horizontal dimensions, such as horizontal cover area size, east/west/south/north boundaries. The time restriction may include a time duration length or a time window in a day, in a month, or in a year.

In some embodiments, to coordinate the sensing, the ISMF entity may select the at least one sensing entity based on the authorization result. The at least one sensing entity may include a sensing transmitter and at least a sensing receiver. The ISMF entity may transmit a sensing service creation message to the at least one sensing entity. The ISMF entity may receive initial sensing data from the sensing receiver.

In some embodiments, to select the at least one sensing entity, the ISMF entity may select the at least one sensing entity based on the authorization result and a local selection policy at the ISMF entity.

In some embodiments, the local selection policy may be configured locally at the ISMF entity or provisioned to the ISMF entity from a network function entity that stores sensing service subscription information.

In some embodiments, the local selection policy may be based on a sensing area, a sensing time, an individual sensing service, or a sensing client.

In some embodiments, to select the at least one sensing entity, the ISMF entity may select the at least one sensing entity based on the authorization result from a sensing authorization function (SAF) entity. The authorization result may indicate the at least one sensing entity.

In some embodiments, the ISMF entity may send, to the ISAC service client, sensing result information based on the initial sensing data.

In some embodiments, the at least one sensing entity may include a base station and a user equipment (UE).

FIG. 6B shows a flow chart of a method 610 performed by an integrated sensing and communication (ISAC) service client, such as the ISAC service client 228, according to some embodiments. The ISAC service client may include computer-readable code or instructions executing on one or more processors of the ISAC service client. Coding of the software for carrying out or performing the method 612 is well within the scope of a person of ordinary skill in the art having regard to the present disclosure. The method 612 may include additional or fewer operations than those shown and described and may be carried out or performed in a different order. Computer-readable code or instructions of the software executable by the one or more processors may be stored on a non-transitory computer-readable medium, such as for example, the memory of the ISAC service client. In some embodiments, the method 612 may be performed by one or more of units or modules (e.g., an integrated circuit) of the ISAC service client, such as one or more field programmable gate arrays (FPGAs) or one more application-specific integrated circuits (ASICs).

The method 610 starts at the operation 612, where the ISAC service client transmits a sensing service request for an ISAC service or an ISAC operation. The sensing service request includes service information for sensing entities associated with the ISAC service or the ISAC operation. At the operation 614, the ISAC service client receives a response to the sensing service request. The response indicates a status of the sensing service request. The status indicates a sensing service authorization success or a sensing service authorization failure.

In some embodiments, the status may indicate the sensing service authorization success. The ISAC service client may receive sensing result information according to the sensing service request.

In some embodiments, the ISAC service client may receive a notification notifying a revocation of sensing service authorization corresponding to the ISAC service or the ISAC operation. The notification may further include a request indicating a subsequent action after the revocation.

In some embodiments, the service information in the sensing service request may indicate at least one of a sensing area, potential target characteristics, a sensing operation time, a frequency of the ISAC service or the ISAC operation.

In some embodiments, the ISAC service client may be or may be part of a user equipment (UE) or an application server.

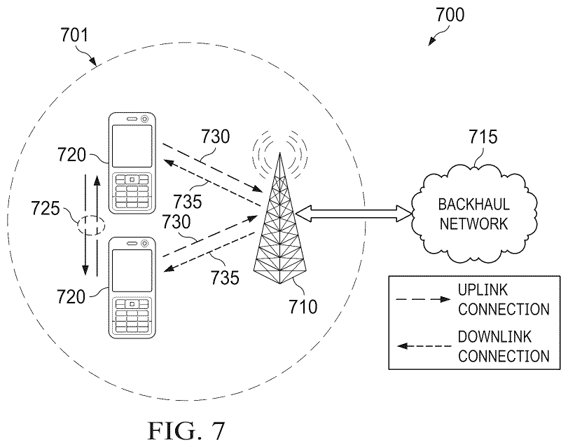

FIG. 7 illustrates an example communications system 700. Communications system 700 includes an access node 710 serving user equipments (UEs) with coverage 701, such as UEs 720. In a first operating mode, communications to and from a UE passes through access node 710 with a coverage area 701. The access node 710 is connected to a backhaul network 715 for connecting to the internet, operations and management, and so forth. In a second operating mode, communications to and from a UE do not pass through access node 710, however, access node 710 typically allocates resources used by the UE to communicate when specific conditions are met. Communications between a pair of UEs 720 can use a sidelink connection (shown as two separate one-way connections 725). In FIG. 7, the sideline communication is occurring between two UEs operating inside of coverage area 701. However, sidelink communications, in general, can occur when UEs 720 are both outside coverage area 701, both inside coverage area 701, or one inside and the other outside coverage area 701. Communication between a UE and access node pair occur over uni-directional communication links, where the communication links between the UE and the access node are referred to as uplinks 730, and the communication links between the access node and UE is referred to as downlinks 735.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

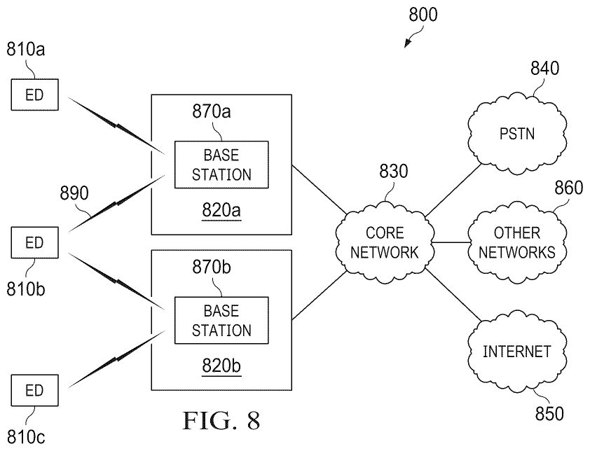

FIG. 8 illustrates an example communication system 800. In general, the system 800 enables multiple wireless or wired users to transmit and receive data and other content. The system 800 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 800 includes electronic devices (ED) 810a-810c, radio access networks (RANs) 820a-820b, a core network 830, a public switched telephone network (PSTN) 840, the Internet 850, and other networks 860. While certain numbers of these components or elements are shown in FIG. 8, any number of these components or elements may be included in the system 800.

The EDs 810a-810c are configured to operate or communicate in the system 800. For example, the EDs 810a-810c are configured to transmit or receive via wireless or wired communication channels. Each ED 810a-810c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 820a-820b here include base stations 870a-870b, respectively. Each base station 870a-870b is configured to wirelessly interface with one or more of the EDs 810a-810c to enable access to the core network 830, the PSTN 840, the Internet 850, or the other networks 860. For example, the base stations 870a-870b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 810a-810c are configured to interface and communicate with the Internet 850 and may access the core network 830, the PSTN 840, or the other networks 860.

In the embodiment shown in FIG. 8, the base station 870a forms part of the RAN 820a, which may include other base stations, elements, or devices. Also, the base station 870b forms part of the RAN 820b, which may include other base stations, elements, or devices. Each base station 870a-870b operates to transmit or receive wireless signals within a particular geographic region or area, sometimes referred to as a “cell.” In some embodiments, multiple-input multiple-output (MIMO) technology may be employed having multiple transceivers for each cell.

The base stations 870a-870b communicate with one or more of the EDs 810a-810c v over one or more air interfaces 890 using wireless communication links. The air interfaces 890 may utilize any suitable radio access technology.

It is contemplated that the system 800 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 820a-820b are in communication with the core network 830 to provide the EDs 810a-810c with voice, data, application, Voice over Internet Protocol (VoIP), or other services. Understandably, the RANs 820a-820b or the core network 830 may be in direct or indirect communication with one or more other RANs (not shown). The core network 830 may also serve as a gateway access for other networks (such as the PSTN 840, the Internet 850, and the other networks 860). In addition, some or all of the EDs 810a-810c may include functionality for communicating with different wireless networks over different wireless links using different wireless technologies or protocols. Instead of wireless communication (or in addition thereto), the EDs may communicate via wired communication channels to a service provider or switch (not shown), and to the Internet 850.

Although FIG. 8 illustrates one example of a communication system, various changes may be made to FIG. 8. For example, the communication system 800 could include any number of EDs, base stations, networks, or other components in any suitable configuration.

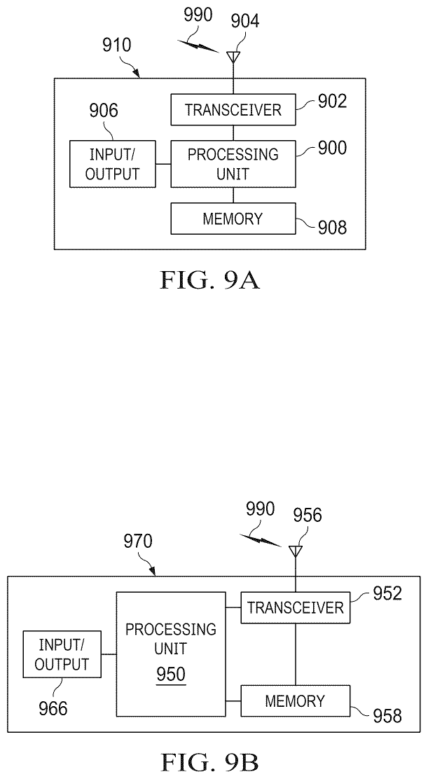

FIGS. 9A and 9B illustrate example devices that may implement the methods and teachings according to this disclosure. In particular, FIG. 9A illustrates an example ED 910, and FIG. 9B illustrates an example base station 970. These components could be used in the system 800 or in any other suitable system.

As shown in FIG. 9A, the ED 910 includes at least one processing unit 900. The processing unit 900 implements various processing operations of the ED 910. For example, the processing unit 900 could perform signal coding, data processing, power control, input/output processing, or any other functionality enabling the ED 910 to operate in the system 800. The processing unit 900 also supports the methods and teachings described in more detail above. Each processing unit 900 includes any suitable processing or computing device configured to perform one or more operations. Each processing unit 900 could, for example, include a microprocessor, microcontroller, digital signal processor, field programmable gate array, or application specific integrated circuit.

The ED 910 also includes at least one transceiver 902. The transceiver 902 is configured to modulate data or other content for transmission by at least one antenna or NIC (Network Interface Controller) 904. The transceiver 902 is also configured to demodulate data or other content received by the at least one antenna 904. Each transceiver 902 includes any suitable structure for generating signals for wireless or wired transmission or processing signals received wirelessly or by wire. Each antenna 904 includes any suitable structure for transmitting or receiving wireless or wired signals. One or multiple transceivers 902 could be used in the ED 910, and one or multiple antennas 904 could be used in the ED 910. Although shown as a single functional unit, a transceiver 902 could also be implemented using at least one transmitter and at least one separate receiver.

The ED 910 further includes one or more input/output devices 906 or interfaces (such as a wired interface to the Internet 850). The input/output devices 906 facilitate interaction with a user or other devices (network communications) in the network. Each input/output device 906 includes any suitable structure for providing information to or receiving information from a user, such as a speaker, microphone, keypad, keyboard, display, or touch screen, including network interface communications.

In addition, the ED 910 includes at least one memory 908. The memory 908 stores instructions and data used, generated, or collected by the ED 910. For example, the memory 908 could store software or firmware instructions executed by the processing unit(s) 900 and data used to reduce or eliminate interference in incoming signals. Each memory 908 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 9B, the base station 970 includes at least one processing unit 950, at least one transceiver 952, which includes functionality for a transmitter and a receiver, one or more antennas 956, at least one memory 958, and one or more input/output devices or interfaces 966. A scheduler, which would be understood by one skilled in the art, is coupled to the processing unit 950. The scheduler could be included within or operated separately from the base station 970. The processing unit 950 implements various processing operations of the base station 970, such as signal coding, data processing, power control, input/output processing, or any other functionality. The processing unit 950 can also support the methods and teachings described in more detail above. Each processing unit 950 includes any suitable processing or computing device configured to perform one or more operations. Each processing unit 950 could, for example, include a microprocessor, microcontroller, digital signal processor, field programmable gate array, or application specific integrated circuit.

Each transceiver 952 includes any suitable structure for generating signals for wireless or wired transmission to one or more EDs or other devices. Each transceiver 952 further includes any suitable structure for processing signals received wirelessly or by wire from one or more EDs or other devices. Although shown combined as a transceiver 952, a transmitter and a receiver could be separate components. Each antenna 956 includes any suitable structure for transmitting or receiving wireless or wired signals. While a common antenna 956 is shown here as being coupled to the transceiver 952, one or more antennas 956 could be coupled to the transceiver(s) 952, allowing separate antennas 956 to be coupled to the transmitter and the receiver if equipped as separate components. Each memory 958 includes any suitable volatile or non-volatile storage and retrieval device(s). Each input/output device 966 facilitates interaction with a user or other devices (network communications) in the network. Each input/output device 966 includes any suitable structure for providing information to or receiving/providing information from a user, including network interface communications.

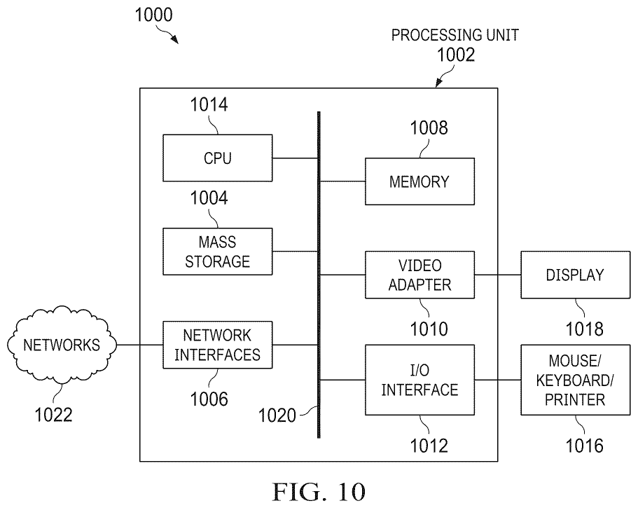

FIG. 10 is a block diagram of a computing system 1000 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1000 includes a processing unit 1002. The processing unit includes a central processing unit (CPU) 1014, memory 1008, and may further include a mass storage device 1004, a video adapter 1010, and an I/O interface 1012 connected to a bus 1020.

The bus 1020 may be one or more of any type of several bus architectures including a memory bus or memory controller, a peripheral bus, or a video bus. The CPU 1014 may comprise any type of electronic data processor. The memory 1008 may comprise any type of non-transitory system memory such as static random access memory (SRAM), dynamic random access memory (DRAM), synchronous DRAM (SDRAM), read-only memory (ROM), or a combination thereof. In an embodiment, the memory 1008 may include ROM for use at boot-up, and DRAM for program and data storage for use while executing programs.

The mass storage 1004 may comprise any type of non-transitory storage device configured to store data, programs, and other information and to make the data, programs, and other information accessible via the bus 1020. The mass storage 1004 may comprise, for example, one or more of a solid state drive, hard disk drive, a magnetic disk drive, or an optical disk drive.

The video adapter 1010 and the I/O interface 1012 provide interfaces to couple external input and output devices to the processing unit 1002. As illustrated, examples of input and output devices include a display 1018 coupled to the video adapter 1010 and a mouse, keyboard, or printer 1016 coupled to the I/O interface 1012. Other devices may be coupled to the processing unit 1002, and additional or fewer interface cards may be utilized. For example, a serial interface such as Universal Serial Bus (USB) (not shown) may be used to provide an interface for an external device.

The processing unit 1002 also includes one or more network interfaces 1006, which may comprise wired links, such as an Ethernet cable, or wireless links to access nodes or different networks. The network interfaces 1006 allow the processing unit 1002 to communicate with remote units via the networks. For example, the network interfaces 1006 may provide wireless communication via one or more transmitters/transmit antennas and one or more receivers/receive antennas. In an embodiment, the processing unit 1002 is coupled to a local-area network 1022 or a wide-area network for data processing and communications with remote devices, such as other processing units, the Internet, or remote storage facilities.

The network functions described in this disclosure (e.g., ISMF 212, SAF 216, UDM 226, AF 228, NWDAF 232, NEF 238, AMF 240, and UPF 242) may be entities running on one or more computing devices, such as one or more computing systems described with respect to FIG. 10. One network function may be an entity running on at least one computing device. In some embodiments, different network functions may be network entities running on different computing devices. In some other embodiments, different network functions may be network entities running on the same computing device.

The following information is incorporated in this disclosure by reference.

### TR22.837 (v0.4.0): Feasibility Study on Integrated Sensing and Communication

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

1. A method, comprising:
receiving, by an integrated sensing and communication (ISAC) service management function (ISMF) entity in a mobile core network from an ISAC service client, a sensing service request for an ISAC service or an ISAC operation, the sensing service request including service information for at least one sensing entity associated with the ISAC service or the ISAC operation;
conducting, by the ISMF entity, an authorization procedure to obtain sensing service authorization to authorize the ISAC service or the ISAC operation; and
coordinating, by the ISMF entity, sensing in accordance with an authorization result of the authorization procedure and the sensing service request.

2. The method of claim 1, the service information in the sensing service request indicating at least one of a sensing area, potential target characteristics, a sensing operation time, a sensing service type, a sensing QoS performance requirement, a frequency of the ISAC service or the ISAC operation.

3. The method of claim 1, the conducting the authorization procedure comprising:
sending, by the ISMF entity, a sensing service authorization request including the service information to one or more network function entities in a network, such that the one or more network function entities are enabled to perform the sensing service authorization based on the service information; and
receiving, by the ISMF entity, the authorization result from the one or more network function entities based on a sensing authorization policy.

4. The method of claim 1, further comprising:
receiving, by the ISMF entity, an update to information or policy related to the sensing service authorization; and
processing, by the ISMF entity, the update to the sensing service authorization.

5. The method of claim 4, the processing the update to the sensing service authorization comprising:
suspending or terminating the sensing on communication resources in response to the update to the sensing service authorization.

6. The method of claim 4, the processing the update to the sensing service authorization comprising:
sending, by the ISMF entity to the at least one sensing entity, a service request indicating the update.

7. The method of claim 1, further comprising:
receiving, by the ISMF entity from a second network function entity, an indicator indicating that the ISAC sensing service previously authorized shall not continue;
sending, by the ISMF entity to the ISAC service client, a notification notifying a revocation of the sensing service authorization; and
sending, by the ISMF entity to one or more network function entities that perform the sensing, a termination request for the one or more network function entities to terminate the ISAC service or the ISAC operation.

8. The method of claim 7, the a indicating that the ISAC sensing service previously authorized shall not continue based on a sensing service policy, the sensing service policy including restriction information, the restriction information indicating at least one of an area restriction, a time restriction, a type of the ISAC service, a quality of service (QoS) of the ISAC service, or a sensing entity.

9. The method of claim 8, the area restriction including vertical and horizontal restrictions, the time restriction including a time duration length or a time window in unit of day, in unit of month, or in unit of year.

10. The method of claim 1, the coordinating the sensing comprising:
selecting, by the ISMF entity, the at least one sensing entity based on the authorization result and a local selection policy, the at least one sensing entity including a sensing transmitter and at least a sensing receiver; and
transmitting, by the ISMF entity, a sensing service creation message to the at least one sensing entity; and
receiving, by the ISMF entity, sensing data from the sensing receiver.

11. The method of claim 10, the local selection policy being configured locally at the ISMF entity or provisioned to the ISMF entity from a network function entity that stores sensing service subscription information.

12. The method of claim 11, the local selection policy being based on a sensing area, a sensing time, sensing entity capability and capacity, an individual sensing service, or a sensing client.

13. The method of claim 1, the at least one sensing entity including at least one of a base station or a user equipment (UE).

14. A method comprising:
transmitting, by an integrated sensing and communication (ISAC) service client, a sensing service request for an ISAC service or an ISAC operation, the sensing service request including service information for sensing entities associated with the ISAC service or the ISAC operation; and
receiving, by the ISAC service client, a response to the sensing service request, the response indicating a status of the sensing service request, the status indicating a sensing service authorization success or a sensing service authorization failure.

15. The method of claim 14, further comprising:
receiving, by the ISAC service client, a notification notifying a revocation of sensing service authorization corresponding to the ISAC service or the ISAC operation, the notification further including a request indicating a subsequent action after the revocation.

16. The method of claim 14, wherein the ISAC service client is or is part of a user equipment (UE) or an application server.

17. An integrated sensing and communication (ISAC) service management function (ISMF) entity, comprising:
at least one processor; and
a non-transitory computer readable storage medium storing programming, the programming including instructions that, when executed by the at least one processor, cause the ISMF entity to perform:
receiving, from an ISAC service client, a sensing service request for an ISAC service or an ISAC operation, the sensing service request including service information for at least one sensing entity associated with the ISAC service or the ISAC operation;
conducting an authorization procedure to obtain sensing service authorization to authorize the ISAC service or the ISAC operation; and
coordinating sensing in accordance with an authorization result of the authorization procedure and the sensing service request.

18. The ISMF entity of claim 17, the service information in the sensing service request indicating at least one of a sensing area, potential target characteristics, a sensing operation time, a sensing service type, a sensing QoS performance requirement, a frequency of the ISAC service or the ISAC operation.

19. An integrated sensing and communication (ISAC) service client, comprising:
at least one processor; and
a non-transitory computer readable storage medium storing programming, the programming including instructions that, when executed by the at least one processor, cause the ISAC client to perform:
transmitting a sensing service request for an ISAC service or an ISAC operation, the sensing service request including service information for sensing entities associated with the ISAC service or the ISAC operation; and
receiving a response to the sensing service request, the response indicating a status of the sensing service request, the status indicating a sensing service authorization success or a sensing service authorization failure.

20. The ISAC service client of claim 19, the instructions, when executed by the at least one processor, further causing the ISAC client to perform:
receiving a notification notifying a revocation of sensing service authorization corresponding to the ISAC service or the ISAC operation, the notification further including a request indicating a subsequent action after the revocation.
